(19) United States
(12) Patent Application Publication
(10) Pub. No.: US 2026/0279932 A1
(43) Pub. Date: Sep. 17, 2026

(54) Battery Cell Thickness Measuring Device and Lamination Device for Secondary Battery Comprising the Same

(71) Applicant: LG Energy Solution, Ltd., Seoul (KR)

(72) Inventor: Woo Jung Jung, Daejeon (KR)

(73) Assignee: LG Energy Solution, Ltd., Seoul (KR)

(21) Appl. No.: 19/168,161

(22) PCT Filed: Jun. 4, 2024
(86) PCT No.: PCT/KR2024/007623

§ 371 Date: Sep. 23, 2025

(30) Foreign Application Priority Data
Jun. 7, 2023 (KR) 10-2023-0073186

(51) Int. Cl. H01M 10/42; G01B 7/00; G01B 7/06; H01M 10/04

(52) U.S. Cl. CPC H01M 10/4285; G01B 7/001; G01B 7/002; G01B 7/06; H01M 10/0404; H01M 10/0468

(57) ABSTRACT

A battery cell thickness measuring device including a pressurizing roller configured to be installed at a first fixed position on a transfer part, configured for contacting a battery cell when the battery cell during transfer passes the first fixed position, and pressurizing the battery cell in a thickness direction of the battery cell, a pressure-sensing film wound around the pressurizing roller and configured to measure the pressure received on the battery cell as the pressurizing roller pressurizes the battery cell, and a control part configured to calculate the thickness of the battery cell based on the pressure measured by the pressure-sensing film is provided.

### CROSS-REFERENCE TO RELATED APPLICATIONS

This application is a 371 National Stage entry of PCT/KR2024/007623, filed on Jun. 4, 2024, which claims the benefit of foreign priority based on Korean Patent Application No. 10-2023-0073186 dated Jun. 7, 2023, the disclosures of which are incorporated by reference herein in their entirety.

### TECHNICAL FIELD

The present disclosure relates to a battery cell thickness measuring device and a lamination device for a secondary battery comprising the same.

### BACKGROUND

There are high demands for rectangular secondary batteries, pouch-type secondary batteries, and the like as secondary batteries used in mobile devices and electric vehicles.

Particularly, pouch-type batteries with a structure in which a stacked or stacked/folded electrode assembly is embedded in a pouch-type battery case have recently attracted a lot of attention due to their low manufacturing cost, small weight, easy shape deformation, and the like.

Accordingly, in a secondary battery production process, a dimensional management of battery cells becomes important to achieve consistent quality of the produced battery cells.

FIG. 1 is a schematic diagram showing a conventional battery cell thickness measuring device (10).

Referring to FIG. 1, the conventional battery cell thickness measuring device (10) has a structure pressurizing a battery cell (50), which is mounted in a stationary state on an upper surface of a base plate (30), using a pressurizing plate (20).

At this time, in a state where the battery cell (50) is pressurized, a touch portion (41) of a drop gauge (40) is passed through a through hole (21) drilled in the pressurizing plate (20), thereby measuring the pressurized depth. measurement, and measuring the thickness of the battery cell (50) based on this measurement.

However, the battery cell thickness measuring device (10) has the risk of damaging the battery cell (50) in the process of pressurizing the battery cell (50), and the drop gauge (40) can only measure the thickness of the battery cell (50) portion where the through hole (21) is formed, thereby having a problem that it is difficult to measure the thickness of other portions.

Also, the touch portion (41) of the drop gauge (40) in contact with the battery cell (50) has weak durability, thereby increasing maintenance and repair costs, and accordingly, repeated measurements are not only limited for a precise thickness measurement, but also when there are foreign substances on the touch portion (41), there is a problem that the precise thickness measurement is difficult.

In addition, since the conventional battery cell thickness measuring device (10) measures the battery cell (50) in a stationary state, in an in-line production process in which the battery cell (50) continuously moves, there is a problem that it is difficult to measure the thickness of the battery cell (50) in real time.

### SUMMARY

### Technical Problem

It is a problem to be solved by the present disclosure to provide a battery cell thickness measuring device capable of measuring thicknesses of battery cells in real time in a process that a plurality of battery cells continuously moves, and a lamination device for a secondary battery comprising the same.

### Technical Solution

In order to solve the above problem, a battery cell thickness measuring device related to one example of the present disclosure comprises a first pressurizing roller installed at a first fixed position on a transfer part, contacting a battery cell when the battery cell during transfer passes the first fixed position, and pressurizing the battery cell in the thickness direction of the battery cell, a first pressure-sensing film wound around the first pressurizing roller and provided to measure the pressure received from the battery cell while the first pressurizing roller pressurizes the battery cell, and a control part calculating the thickness of the battery cell based on the pressure measured by the first pressure-sensing film.

Also, the first pressure-sensing film may be provided so that the pressure received from the battery cell increases as the thickness of the battery cell increases.

In addition, the battery cell thickness measuring device may comprise a first fixing block positioned at a predetermined distance away from the transfer part at the first fixed position, and a first elastic connection member elastically connecting the first fixing block and the first pressurizing roller.

Furthermore, the first pressurizing roller may be provided to enable idle-rotation.

Also, the control part may be provided to compare the calculated thickness of the battery cell with the predetermined standard thickness of the battery cell. In addition, the control part may be provided to calculate the difference between the calculated thickness of the battery cell and the predetermined standard thickness of the battery cell.

Furthermore, if the difference between the predetermined standard thickness of the battery cell and the calculated thickness of the battery cell is outside an acceptable error range, the control part may determine a quality of the battery cell to be defective.

Also, the battery cell thickness measuring device may comprise a display part displaying the quality state of the battery cell.

In addition, the control part may be provided to control the operation of the transfer part based on the quality state of the battery cell.

Furthermore, the battery cell thickness measuring device may comprise a second pressurizing roller installed at a second fixed position spaced apart from the first fixed position along the transfer direction of the battery cell, contacting the battery cell when the battery cell during transfer passes the second fixed position, and pressurizing the battery cell in the thickness direction of the battery cell, and a second pressure-sensing film wound around the second pressurizing roller and measuring the pressure received from the battery cell while the second pressurizing roller pressurizes the battery cell.

Also, the battery cell thickness measuring device may comprise a second fixing block positioned at a predetermined distance away from the transfer part at the second fixed position, and a second elastic connection member elastically connecting the second fixing block and the second pressurizing roller.

In addition, the second pressurizing roller may be provided to enable idle-rotation.

Furthermore, the control part may be provided to calculate the thickness of the battery cell based on the pressures measured by the first and second pressure-sensing films.

Also, the transfer part may comprise a conveyor.

In addition, a lamination device for a secondary battery related to one example of the present disclosure may comprise a laminate part including a rolling roller rolling battery cells on which electrodes and separators are laminated, a transfer part provided to transfer battery cells on which laminating is completed, and a battery cell thickness measuring device installed on the transfer path of the transfer part. In addition, the battery cell thickness measuring device comprises a first pressurizing roller installed at a first fixed position on a transfer part, contacting a battery cell when the battery cell during transfer passes the first fixed position, and pressurizing the battery cell in the thickness direction of the battery cell, a first pressure-sensing film wound around the first pressurizing roller and provided to measure the pressure received from the battery cell while the first pressurizing roller pressurizes the battery cell, and a control part calculating the thickness of the battery cell based on the pressure measured by the first pressure-sensing film.

Furthermore, if the difference between the predetermined standard thickness of the battery cell and the calculated thickness of the battery cell is outside an acceptable error range, the control part may be provided to determine a quality of the battery cell to be defective.

Also, the control part may be provided to control the operation of the laminate part based on the quality state of the battery cell.

In addition, the control part may be provided to control the operation of the transfer part based on the quality state of the battery cell.

Furthermore, according to another aspect of the present disclosure, as a device that on a conveyor sequentially transferring battery cells with a predetermined thickness in which electrodes and separators are alternately laminated, the thicknesses of the battery cells are continuously measured, a battery cell thickness measuring device may be provided, which comprises a pressurizing roller installed at a fixed position on the conveyor, contacting the battery cell when the battery cell during transfer passes the fixed position, and pressurizing the surface of the battery cell while changing its height in the thickness direction of the battery cell; a pressure-sensing film wound around the pressurizing roller and measuring the pressure received from the surface of the battery cell while the pressurizing roller pressurizes the battery cell, and a control part calculating the thickness of the battery cell based on the pressure measured by the pressure-sensing film.

In addition, according to another aspect of the present disclosure, as a device that on a conveyor sequentially transferring battery cells with a predetermined thickness in which electrodes and separators are alternately laminated, the thicknesses of the battery cells are continuously measured, a battery cell thickness measuring device may be provided, which comprises a first pressurizing roller installed at a first fixed position on the conveyor, contacting the battery cell when the battery cell during transfer passes the fixed position, and pressurizing the surface of the battery cell while changing its height in the thickness direction of the battery cell, a first pressure-sensing film wound around the first pressurizing roller and measuring the pressure received from the surface of the battery cell while the first pressurizing roller pressurizes the battery cell, a second pressurizing roller installed at a second fixed position spaced apart from the first fixed position along the transport direction of the battery cell, contacting the battery cell when the battery cell during transfer passes the fixed position, and pressurizing the surface of the battery cell while changing its height in the thickness direction of the battery cell, a second pressure-sensing film wound around the second pressurizing roller and measuring the pressure received from the surface of the battery cell while the second pressurizing roller pressurizes the battery cell, and a control part provided to calculate the thickness of the battery cell based on the pressures measured by the first and second pressure-sensing films.

### Advantageous Effects

As discussed above, the battery cell thickness measuring device related to at least one example of the present disclosure and the lamination device for a secondary battery comprising the same have the following effects.

It is possible to calculate the thickness of the battery cell based on the pressure that the pressure-sensing film wound around the pressurizing roller receives from the battery cell.

Also, in a process in which a plurality of battery cells continuously moves, it is possible to measure the thicknesses of the battery cells in real time.

In addition, it is possible to continuously measure the thicknesses of a plurality of battery cells in real time on a conveyor that the plurality of battery cells continuously moves.

### BRIEF DESCRIPTION OF THE DRAWINGS

FIG. 1 is a schematic diagram showing a conventional battery cell thickness measuring device.

FIG. 2 is a diagram showing a battery cell thickness measuring device according to one example of the present disclosure.

FIG. 3 is a schematic diagram showing the battery cell shown in FIG. 2.

FIG. 4 is a configuration diagram showing a battery cell thickness measuring device and a lamination device for a secondary battery according to one example of the present disclosure.

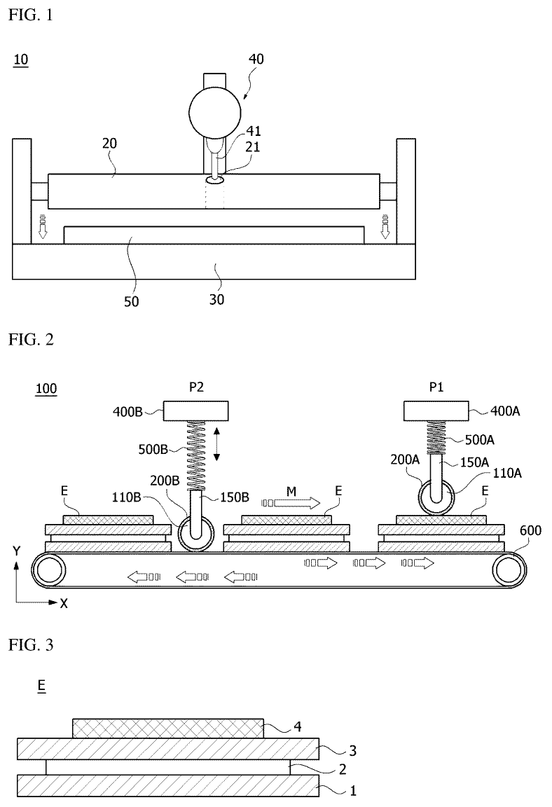

### MODE FOR DISCLOSURE

Hereinafter, with reference to the accompanying drawings, a battery cell thickness measuring device related to one example of the present disclosure, and a lamination device for a secondary battery comprising the same will be described.

In addition, regardless of the reference numerals, the same or corresponding components are given by the same or similar reference numerals, duplicate descriptions thereof will be omitted, and for convenience of explanation, the size and shape of each component member as shown can be exaggerated or reduced.

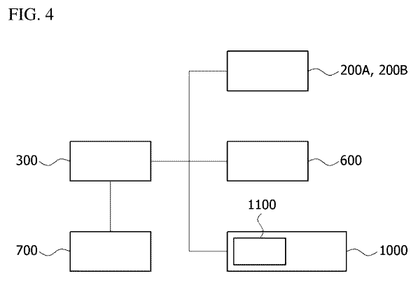

FIG. 2 is a diagram showing a battery cell thickness measuring device (100) according to one example of the present disclosure, FIG. 3 is a schematic diagram showing the battery cell (E) shown in FIG. 2, and FIG. 4 is a configuration diagram showing a battery cell thickness measuring device and a lamination device for a secondary battery according to one example of the present disclosure.

The battery cell thickness measuring device (100) according to one example of the present disclosure is a device continuously calculating thicknesses of battery cells (E) on a transfer part (600) sequentially transferring battery cells (E) with a predetermined thickness in which electrodes and separators are alternately laminated.

The battery cell thickness measuring device (100) may comprise a transfer part (600) sequentially transferring battery cells (E) with a predetermined thickness in which electrodes and separators are alternately laminated. The transfer part (600) may comprise a conveyor, or a plurality of transfer rolls. Hereinafter, for convenience of explanation, the transfer part (600) will be described as an example which is a conveyor.

The battery cell thickness measuring device (100) may be a device applied to an electrode assembly process of a secondary battery manufacturing process, for example, may be a device used in a lamination process.

Referring to FIGS. 2 and 3, the battery cell (E) may comprise electrodes and separators, and the battery cell (E) may comprise unit cells in which electrodes and separators are alternately laminated. As one example, the unit cell may comprise a first separator (1), a negative electrode (2) laminated on the first separator (1), a second separator (3) laminated on the negative electrode (2), and a positive electrode (4) laminated on the second separator (3).

A lamination device for a secondary battery related to one example of the present disclosure may comprise a laminate part (1000) including a rolling roller (1100) rolling battery cells (E) in which electrodes and separators are laminated, and a transfer part (600) provided to transfer the battery cells on which laminating is completed, and a battery cell thickness measuring device (100) installed on the transfer path of the transfer part (600).

The battery cell thickness measuring device (100) may be installed on the transfer path (M) where the battery cells (E), on which the laminating process is completed, are transferred to the next process, and may measure the thickness of a plurality of battery cells (E) during transfer continuously and in real time.

Also, the battery cell thickness measuring device (100) may contribute to managing a laminating quality by measuring the thickness of the battery cell (E).

For example, when the difference between the thickness of the battery cell (E) calculated from the battery cell thickness measuring device (100) and the predetermined standard thickness of the battery cell (E) is outside the acceptable error range, it may be determined that the laminate quality of the battery cell (E) is defective. In this document, standard thickness means a thickness of a good battery cell after the lamination process.

Referring to FIGS. 2 to 4, the battery cell thickness measuring device (100) according to the present disclosure comprises a first pressurizing roller (110A), a first pressure-sensing film (200A), and a control part (300).

In this document, the X-axis direction represents the transport direction (M) of the battery cells (E), and the Y-axis direction represents the laminating direction or thickness direction of the battery cells (E). In addition, the Y-axis direction may be the up and down direction of the first pressurizing roller (110A).

The first pressurizing roller (110A) is installed at a first fixed position (P1) on the conveyor (600), and provided to pressurize the surface of the battery cell (E) in the thickness direction (Y-axis direction) of the battery cell (E) when the battery cell (E) during transfer passes the first fixed position (P1). The first pressurizing roller (110A) may be provided so that its height changes in the thickness direction (Y-axis direction) of the battery cell (E) when it contacts the battery cell (E). That is, in the process of passing the battery cell (E), the first pressurizing roller (110A) may be provided to rise by the thickness of the battery cell (E). Of course, a force acts on the first pressurizing roller (110A) in a direction of pressurizing the surface of the battery cell (E) along the thickness direction of the battery cell (E).

Also, the first pressurizing roller (110A) may be installed to be movable up and down in place (first fixed position) along the thickness direction of the battery cell (E). When the battery cell (E) passes the first fixed position (P1), it may be positioned between the conveyor (600) and the first pressurizing roller (110A).

In addition, the first pressurizing roller (110A) may form a space which is spaced apart from the upper surface of the conveyor (600) and through which the battery cells (E) pass. The size of the space may vary depending on the thickness of the battery cell (E).

The first pressure-sensing film (200A) is wound around the first pressurizing roller (110A), and provided to measure the pressure received from the surface of the battery cell (E) while the first pressurizing roller (110A) pressurizes the battery cell (E).

The pressure received by the first pressure-sensing film (200A) may vary depending on the thickness of the battery cell (E), and accordingly, the pressure measured on the first pressure-sensing film (200A) may vary depending on the thickness of the battery cell (E).

Also, the first pressure-sensing film (200A) may be provided to measure the pressure continuously and in real time. For example, the control part (300) may measure the pressure in a time unit of 50 ms or less, 30 ms or less, 20 ms or less, 10 ms or less, 5 ms or less, or 1 ms or less.

In addition, the control part (300) calculates the thickness of the battery cell (E) based on the pressure measured by the first pressure-sensing film (200A). The control part (300) may continuously calculate the thickness of the battery cell (E) from the pressure measured by the first pressure-sensing film (200A).

As one example, when the battery cell (E) comprises a first separator (1), a negative electrode (2) laminated on the first separator (1), a second separator (3) laminated on the negative electrode (2), and a positive electrode (4) laminated on the second separator (3), in the process that the battery cell (E) during transfer passes the first pressurizing roller (110A), the first pressurizing roller (110A) moves up along the thickness direction (Y-axis direction) of the battery cell.

When the first pressurizing roller (110A) contacts the positive electrode surface forming the uppermost surface of the battery cell (E), in the process that it passes the surface of the positive electrode (4) of the battery cell (E), the pressure measured from the first pressure-sensing film (200A) may have a constant value, or may be measured in a value within a predetermined range, and the control part (300) may calculate the thickness of the battery cell (E) based on the pressure pressurizing the positive electrode surface.

The control part (300) may calculate the thickness of each of the plurality of battery cells (E) for each pressure measurement time. A user can know the locations of the battery cells (E) corresponding to the thickness values provided from the control part (300), based on the already known length of the battery cell (E) along the transfer direction (M).

Also, the control part (300) may calculate the thickness of the battery cell (E) from the pressure received by the first pressure-sensing film (200A) using a computer program.

For example, by storing the relationship between the pre-stored pressure of the first pressure-sensing film (200A) and the thickness of the battery cell (E) as data in advance, the control part (300) may measure the thickness of the battery cell (E) based on this.

In addition, the battery cell thickness measuring device (100) according to one example of the present disclosure may comprise a storage part storing thickness data information of the battery cell (E) according to the pressure of the first pressure-sensing film (200A).

The control part (300) may calculate the thickness of the battery cell (E) corresponding to the pressure measured from the first pressure-sensing film (200A) utilizing the stored data information. For example, the data information may comprise information that the thickness of the battery cell (E) is a value of B when the pressure measured from the first pressure-sensing film (200A) (value measured in the process of passing through the positive electrode surface of the battery cell) is a value of A, and may comprise information that the thickness of the battery cell (E) is a value of D when the pressure measured from the first pressure-sensing film (200A) (value measured in the process of passing through the positive electrode surface of the battery cell) is a value of C. When the pressure measured from the first pressure-sensing film (200A) is the value of A, the control part (300) may calculate the value of B, which is the thickness of the battery cell (E), corresponding to the value of A stored in the data information, thereby providing it to the user.

In one example, as the thickness of the battery cell (E) increases, the pressure that the first pressure-sensing film (200A) receives from the surface of the battery cell (E) may increase. As the thickness of the battery cell (E) increases, the first pressure-sensing film (200A) has an increased force to be pressurized from the surface of the contacted battery cell (E), whereby the received pressure may increase.

The battery cell thickness measuring device (100) may comprise a first fixing block (400A) located at a predetermined distance from the upper surface of the conveyor (600) at the first fixed position (P1), and a first elastic connection member (500A) elastically connecting the first fixing block (400A) and the first pressurizing roller (110A). The first elastic connection member (500A) may comprise a spring.

As the first elastic connection member (500A) is elastically connected to the first fixing block (400A), the first pressurizing roller (110A) may move up and down in place (first fixed position) depending on the thickness change of the battery cell (E). As one example, in the process that the first pressurizing roller (110A) passes the battery cell, the first pressurizing roller (110A) rises, and the first elastic connection member (500A) is compressed, and when the first pressurizing roller (110A) passes the battery cell and then leaves the battery cell, the first pressurizing roller (110A) descends, and the first elastic connection member (500A) is released from its compressed state.

The battery cell thickness measuring device (100) may comprise a first mounting frame (150A) on which the first pressurizing roller (110A) is rotatably mounted at the first fixed position (P1).

In this instance, as the first mounting frame (150A) is elastically connected to the first fixing block (400A) by the first elastic connecting member (500A), the first mounting frame (150A) may move up and down in place (first fixed position) depending on the thickness change of the battery cell (E).

In one example, the first pressurizing roller (110A) may be provided to enable idle-rotation. That is, the first pressurizing roller (110A) may be mounted on the first mounting frame (150A) to enable idle-rotation. When the battery cell (E) passes the first fixed position (P1), the first pressurizing roller (110A) enables idle-rotation along the surface of the battery cell (E) while maintaining a state in contact with the surface of the battery cell (E).

In one aspect, if the first pressure-sensing film (200A) is a product which can be wound around the first pressurizing roller (110A) in the form of a film and measure pressure applied from the outside, the type is not particularly limited, and for example, Kaitronics' products may be used.

The control part (300) may be provided to determine the quality of the battery cell (E) based on the calculated thickness of the battery cell (E). By determining the quality (laminating quality) of the battery cells (E), it is possible to enable the consistent quality management of the battery cells (E).

For example, if the difference between the predetermined standard thickness of the battery cell (E) and the calculated thickness of the battery cell (E) is outside the acceptable error range, the control part (300) may determine the quality of the battery cell (E) to be defective. For example, when the battery cell measuring device (100) according to the present disclosure is applied to a laminate process, the defect may mean a poor laminate quality.

Also, if the difference between the predetermined standard thickness of the battery cell (E) and the calculated thickness of the battery cell (E) is within the acceptable error range, the control part (300) may determine the quality of the battery cell (E) to normal or good.

In addition, the battery cell thickness measuring device (100) may comprise a display part (700) displaying the quality state of the battery cell (E). The display part (700) may display the quality state of the battery cell (E) as good or bad on the screen.

Furthermore, the battery cell thickness measuring device (100) may comprise a notification part sounding an alarm when the quality of the battery cell (E) is poor.

Also, the control part (300) may control the operation of the conveyor (600) based on the quality state of the battery cells (E). In one example, the control part (300) may stop the operation of the conveyor (600) when the quality of the battery cell (E) is poor, and as such, by preventing the battery cell (E) of poor quality and the battery cell (E) of good quality from being mixed, it is possible to achieve an excellent quality management of the battery cells (E).

In addition, the battery cell thickness measuring device (100) may be provided to measure the thicknesses of the battery cells (E) at a plurality of positions, respectively, along the transfer direction (M) of the battery cells (E).

The battery cell thickness measuring device (100) may comprise a second pressurizing roller (110B) and a second pressure-sensing film (200B).

The second pressurizing roller (110B) is installed at a second fixed position (P2) on the conveyor (600), and provided to pressurize the battery cell (E) in the thickness direction (Y-axis direction) of the battery cell (E) when the battery cell (E) during transfer passes the second fixed position (P2).

The second pressurizing roller (110B) may be provided so that its height changes in the thickness direction (Y-axis direction) of the battery cell (E) when it contacts the battery cell (E). That is, in the process of passing the battery cell (E), the second pressurizing roller (110B) may be provided to rise by the thickness of the battery cell (E). Of course, a force acts on the second pressurizing roller (110B) in a direction of pressurizing the surface of the battery cell (E) along the thickness direction of the battery cell (E).

Also, the second pressurizing roller (110B) is installed at a second fixed position (P2) spaced apart from the first fixed position (P1) along the transfer direction of the battery cell (E), and provided to contact the battery cell (E) when the battery cell (E) during transfer passes the second fixed position (P2).

In addition, the second pressurizing roller (100B) may be installed to be movable up and down in place (second fixed position) along the thickness direction of the battery cell (E). When the battery cell (E) passes the second fixed position (P2), it may be positioned between the conveyor (600) and the second pressurizing roller (110B).

Furthermore, the second pressurizing roller (110B) may form a space which is spaced apart from the upper surface of the conveyor (600) and through which the battery cells (E) passes. The size of the space may vary depending on the thickness of the battery cell (E).

The second pressure-sensing film (200B) is wound around the second pressurizing roller (110B), and provided to measure the pressure received from the surface of the battery cell (E) while the second pressurizing roller (110B) pressurizes the battery cell (E).

The pressure received by the second pressure-sensing film (200B) may vary depending on the thickness of the battery cell (E), and accordingly, the pressure measured from the second pressure-sensing film (200B) may vary depending on the thickness of the battery cell (E).

Also, the second pressure-sensing film (200B) may be provided to measure pressure continuously and in real time. For example, the control part (300) may measure pressure in a time unit of 50 ms or less, 30 ms or less, 20 ms or less, 10 ms or less, 5 ms or less, or 1 ms or less.

In addition, the control part (300) calculates the thickness of the battery cell (E) based on the pressure measured by the second pressure-sensing film (200B). The control part (300) may continuously calculate the thickness of the battery cell (E) from the pressure measured by the second pressure-sensing film (200B).

Furthermore, the control part (300) calculates the thickness of the battery cell (E) based on the pressure measured by the first pressure-sensing film (200A). The control part (300) may continuously calculate the thickness of the battery cell (E) from the pressure measured by the first pressure-sensing film (200A).

As one example, when the battery cell (E) comprises a first separator (1), a negative electrode (2) laminated on the first separator (1), a second separator (3) laminated on the negative electrode (2), and a positive electrode (4) laminated on the second separator (3), in the process that the battery cell (E) during transfer passes the second pressurizing roller (110B), the second pressurizing roller (110B) moves up along the thickness direction (Y-axis direction) of the battery cell.

When the second pressurizing roller (110B) contacts the positive electrode surface forming the uppermost surface of the battery cell (E), in the process that it passes the surface of the positive electrode (4) of the battery cell (E), the pressure measured from the second pressure-sensing film (200B) may have a constant value, or may be measured in a value within a predetermined range, and the control part (300) may calculate the thickness of the battery cell (E) based on the pressure pressurizing the positive electrode surface.

The battery cell thickness measuring device (100) may comprise a second fixing block (400B) located at a predetermined distance from the upper surface of the conveyor (600) at the second fixed position (P2), and a second elastic connection member (500B) elastically connecting the second fixing block (400B) and the second pressurizing roller (110B). The second elastic connection member (500B) may comprise a spring.

As the second elastic connection member (500B) is elastically connected to the second fixing block (400B), the second pressurizing roller (110B) may move up and down in place depending on the thickness change of the battery cell (E).

As one example, in the process that the second pressurizing roller (110B) passes the battery cell, the second pressurizing roller (110B) rises, and the second elastic connection member (500B) is compressed, and when the second pressurizing roller (110B) passes the battery cell and then leaves the battery cell, the second pressurizing roller (110B) descends, and the second elastic connection member (500B) is released from its compressed state.

The battery cell thickness measuring device (100) may comprise a second mounting frame (150B) on which the second pressurizing roller (110B) is rotatably mounted at the second fixed position (P2).

In this instance, as the second mounting frame (150B) is elastically connected to the second fixing block (400B) by the second elastic connecting member (500B), the second mounting frame (150B) may move up and down in place (second fixed position) depending on the thickness change of the battery cell (E).

In one example, the second pressurizing roller (110B) may be provided to enable idle-rotation. That is, the second pressurizing roller (110B) may be mounted on the second mounting frame (150B) to enable idle-rotation. When the battery cell (E) passes the second fixed position (P2), the second pressurizing roller (110B) enables idle-rotation along the surface of the battery cell (E) while maintaining a state in contact with the surface of the battery cell (E).

In one aspect, if the second pressure-sensing film (200B) is a product which can be wound around the second pressurizing roller (110B) in the form of a film and measure pressure applied from the outside, the type is not particularly limited, and for example, KITRONYX brand products may be used.

In this document, the method of measuring the thickness of the battery cell (E) through the first pressure-sensing film (200A) at the first fixed position (P1) and the method of measuring the thickness of the battery cell (E) by the second pressure-sensing film (200B) at the second fixed position (P2) are the same.

The battery cell thickness measuring device (100) installs the plurality of pressurizing rollers at the plurality of fixed positions, whereby it is possible to increase the reliability of the calculated thickness measurement value of the battery cell (E).

In one example, the control part (300) calculates the average thickness value of the battery cell from the average value of the pressure values measured in the plurality of pressure-sensing films (200A, 200B), whereby it is possible to increase the reliability of the thickness measurement value of the battery cell.

A lamination device for a secondary battery related to one example of the present disclosure may comprise a laminate part (1000) in which electrodes and separators are alternately laminated to laminate a battery cell (E) having a predetermined thickness.

Also, the lamination device for a secondary battery may comprise a conveyor (600) continuously transferring a plurality of battery cells in which laminating is completed.

In addition, the lamination device for a secondary battery comprises a battery cell thickness measuring device (100) installed on the transfer path of the conveyor (600). The battery cell (E) transferred to the conveyor (600) may be a battery cell (E) in which the laminating process is completed.

As previously described, the battery cell thickness measuring device (100) may comprise one or more pressurizing rollers installed at one or more fixed positions on the conveyor (600) and pressurizing a surface of a battery cell (E) while their heights change depending on the thickness change of the battery cell (E) when the battery cell (E) during transfer passes the fixed positions, pressure-sensing films wound around the pressurizing rollers and provided to measure the pressure received from the surface of the battery cell (E) while the pressurizing roller pressurizes the battery cell (E), and a control part provided to calculate the thickness of the battery cell (E) based on the pressures measured by the pressure-sensing films.

Also, the control part (300) may be provided to control the operation of the laminate part (1000) based on the quality state of the battery cell.

The laminate part (1000) may comprise a pair of rolling rollers (1100), and may have a structure in which it allows the battery cells (E) to pass between the pair of rolling rollers (1100) upon the lamination process.

If the difference between the predetermined standard thickness of the battery cell (E) and the calculated thickness of the battery cell (E) is outside the acceptable error range, the control part (300) may determine the quality of the battery cell (E) to be defective. At this time, the control part (300) may also adjust the gap between the pair of rolling rollers (1100), and the control part (300) may also adjust the load applied to the pair of rolling rollers (1100).

In addition, the control part may be provided to control the operation of the transfer part (600) based on the quality state of the battery cell. In one example, the control part (300) may stop the operation of the conveyor (600) when the quality of the battery cell (E) is poor, and as such, it may prevent the battery cell (E) of poor quality and the battery cell (E) of good quality from being mixed.

The preferred examples of the present disclosure as described above have been disclosed for illustrative purposes, and those skilled in the art having ordinary knowledge of the present disclosure will be able to make various modifications, changes, and additions within the spirit and scope of the present disclosure, and such modifications, changes, and additions should be regarded as falling within the scope of the following claims.

### INDUSTRIAL APPLICABILITY

According to the battery cell thickness measuring device related to at least one example of the present disclosure, and the lamination device for a secondary battery comprising the same, it is possible to measure thicknesses of battery cells in real time during a process that a plurality of battery cells continuously moves.

1. A battery cell thickness measuring device comprising:
a pressurizing roller configured to be installed at a first fixed position over a transfer part, configured for contacting a battery cell when the battery cell, during transfer, passes the first fixed position, and pressurizing the battery cell in a thickness direction of the battery cell;
a pressure-sensing film wound around the pressurizing roller and configured to measure the pressure on the battery cell as the pressurizing roller pressurizes the battery cell; and
a control part configured to calculate the thickness of the battery cell based on the pressure measured by the pressure-sensing film.

2. The battery cell thickness measuring device according to claim 1, wherein
the pressure-sensing film is configured so that the pressure on the battery cell corresponds to the thickness of the battery cell.

3. The battery cell thickness measuring device according to claim 1, further comprising:
a fixing block configured to be positioned at a predetermined distance away from the transfer part; and
an elastic connection member elastically connected between the fixing block and the pressurizing roller.

4. The battery cell thickness measuring device according to claim 1, wherein
the pressurizing roller is configured for idle-rotation.

5. The battery cell thickness measuring device according to claim 1, wherein
the control part is configured to calculate a difference between the calculated thickness of the battery cell and a predetermined standard thickness.

6. The battery cell thickness measuring device according to claim 5, wherein
when the difference between the predetermined standard thickness of the battery cell and the calculated thickness of the battery cell is outside an acceptable error range, the control part is configured to determine a quality state of the battery cell to be defective.

7. The battery cell thickness measuring device according to claim 6, further comprising:
a display part displaying the quality state of the battery cell as defective.

8. The battery cell thickness measuring device according to claim 6, wherein
the control part is configured to control the operation of the transfer part based on the quality state of the battery cell.

9. The battery cell thickness measuring device according to claim 1, further comprising:
a second pressurizing roller installed at a second fixed position and spaced apart from the first fixed position along the transfer direction of the battery cell, configured for contacting the battery cell when the battery cell, during transfer, passes the second fixed position, and pressurizing the battery cell in the thickness direction of the battery cell; and
a second pressure-sensing film wound around the second pressurizing roller and configured to measure the pressure on the battery cell as the second pressurizing roller pressurizes the battery cell.

10. The battery cell thickness measuring device according to claim 9, wherein
the control part is configured to calculate the thickness of the battery cell based on the pressure measured by the pressure-sensing film and a pressure measured by the second pressure-sensing film.

11. The battery cell thickness measuring device according to claim 1, wherein
the transfer part includes a conveyor.

12. A lamination device for a secondary battery comprising:
a laminate part including a rolling roller rolling battery cells on which electrodes and separators are laminated;
a transfer part configured to transfer battery cells on which laminating is completed; and
the battery cell thickness measuring device according to claim 1 installed on the transfer path of the transfer part.

13. The lamination device for a secondary battery according to claim 12, wherein
when a difference between a predetermined standard thickness and the calculated thickness of the battery cell is outside of an acceptable range, the control part is configured determines a quality state of the battery cell to be defective.

14. The lamination device for a secondary battery according to claim 13, wherein
the control part is configured to control the operation of the laminate part based on the quality state of the battery cell.

15. The lamination device for a secondary battery according to claim 13, wherein
the control part is configured to control the operation of the transfer part based on the quality state of the battery cell.
